(19) United States
(12) Patent Application Publication
(10) Pub. No.: US 2026/0041278 A1
(43) Pub. Date: Feb. 12, 2026

(54) FLOW PRESSURE FRYER

(71) Applicant: CFA Properties, Inc., Atlanta, GA (US)

(72) Inventors: Christopher Halford, Atlanta, GA (US); Phil McKee, Richardson, TX (US); Michael Carew, Richardson, TX (US); Andy Podevels, Richardson, TX (US)

(21) Appl. No.: 19/295,059

(22) Filed: Aug. 8, 2025

Related U.S. Application Data
(60) Provisional application No. 63/680,668, filed on Aug. 8, 2024.

(51) Int. Cl. A47J 37/12; A23L 5/10

(52) U.S. Cl. CPC A47J 37/1214; A23L 5/11; A47J 37/1223; A47J 37/1233

(57) ABSTRACT

Embodiments of the present disclosure relate to a system and method for food product frying. An example system includes a frying chamber configured to hold a volume of heated cooking oil, the frying chamber comprising: a first end and second end defining a length of the frying chamber; and an internal conveyor configured to receive and horizontally translate a food product carrier through the heated cooking oil along at least a portion of the length of the frying chamber. The system may further include an inlet airlock at the first end, the inlet airlock configured to receive the food product carrier and translate the food product carrier into the frying chamber. The system may further include an outlet airlock at the second end, the outlet airlock configured to receive the food product carrier from the internal conveyor and translate the food product carrier out of the frying chamber.

### CROSS REFERENCE TO RELATED APPLICATIONS

This application claims the benefit of and priority to U.S. Application No. 63/680,668, filed Aug. 8, 2024, entitled “FLOW PRESSURE FRYER,” the disclosure of which is incorporated herein by reference in its entirety.

### TECHNICAL FIELD

This application generally relates to systems and processes for improving efficiency of fried product preparation.

### BACKGROUND

In quick-service restaurants (QSR), distribution centers (DCs), and/or the like, food products are commonly fried in batches. Frying generally refers to the cooking of food within a volume of oil, fat, and/or the like. Historically, QSRs have prepared fried food products, such as breaded chicken, by lowering a container comprising multiple coated products into a vat or pot of heated oil. However, such approaches may result in inefficiencies and unnecessary delays due to unequal frying times amongst the batched products. For example, the batched products may demonstrate variable frying times based on their arrangement within the container and resultant differences in oil temperature that occur throughout the container. A subset of products may reach an optimal fry temperature earlier than other batched products; however, the batch may not be extracted from the vat until the remaining subset of batched products reach an adequate fry temperature.

In addition, the food products are typically maintained as chilled or frozen before being placed into the vat. When a large number of such products are placed in a vat at the same time, such as with the batched approach, then the temperature of the fry oil is measurably decreased. As a result, it takes some time for the heated oil to regain the desired temperature setpoint, resulting in extended cook times and also potentially decreased food quality because the products sit for some time in below-temperature cooking oil.

In addition, with batched approaches, the vats are typically pressure fryers that have a top lid that is opened to place the uncooked food products therein, closed to allow the pressure frying, and then opened again to remove the food products once cooked. Each time the lid is opened after a fry operation is completed, a quantity of steam is released from the vat. This steam causes an increase in the temperature and humidity of the kitchen of a QSR, and for busy kitchens, the increase can require increased HVAC capacity to maintain the temperature and humidity of the kitchen within acceptable limits.

For these reasons, among others, the batched approach may result in time inefficiencies and large variances in cook quality. Thus, QSRs and DCs have not yet solved the challenges of efficiently and evenly frying food products.

### BRIEF SUMMARY

Embodiments of the present disclosure relate to apparatuses, devices, systems, and methods for frying food products. An example apparatus for frying food products may include a frying chamber configured to hold a volume of heated cooking oil. The frying chamber may comprise a first end and second end defining a length of the frying chamber. The frying chamber may further comprise internal conveyor configured to receive and horizontally translate a food product carrier through the volume of heated cooking oil along at least a portion of the length of the frying chamber. The frying chamber may further comprise an inlet airlock at the first end, the inlet airlock configured to receive the food product carrier and translate the food product carrier into the frying chamber. The frying chamber may further comprise an outlet airlock at the second end, the outlet airlock configured to receive the food product carrier from the internal conveyor and translate the food product carrier out of the frying chamber.

In some embodiments, the inlet airlock comprises: a first door configured to transition between an open state exposing the inlet airlock to an external environment and a closed state sealing the inlet airlock from the external environment; and a second door configured to transition between an open state exposing the inlet airlock to the frying chamber and a closed state sealing the inlet airlock from the frying chamber. In some embodiments, a bottom surface of the inlet airlock comprises the second door of the inlet airlock; and the second door of the inlet airlock is configured to rotate between the open state and the closed state. In some embodiments, in the open state, the second door of the inlet airlock defines a slope extending toward the internal conveyor.

In some embodiments, the outlet airlock comprises: a first door configured to transition between an open state exposing the outlet airlock to the frying chamber and a closed state sealing the outlet airlock from the frying chamber; and a second door configured to transition between an open state exposing the outlet airlock to an external environment and a closed state sealing the outlet airlock from the external environment. In some embodiments, a bottom surface of the outlet airlock comprises the second door of the outlet airlock; and the second door of the outlet airlock is configured to rotate between the open state and the closed state. In some embodiments, in the open state, the second door of the outlet airlock defines a slope extending into the external environment.

In some embodiments, the frying system further comprises a mechanism configured to translate the food product carrier from the internal conveyor into the outlet airlock. In some embodiments, the frying system further comprises a filtration system configured to: receive cooking oil from the frying chamber; filter the cooking oil; and recirculate the filtered cooking oil into the frying chamber. In some embodiments, the frying system further comprises a heating system configured to heat the filtered cooking oil before recirculation into the frying chamber. In some embodiments, the frying chamber comprises a sloped bottom surface configured to direct particulates and residues toward an inlet to the filtration system.

In some embodiments, the frying chamber is configured to maintain a pressurized cooking environment. In some embodiments, the food product carrier is configured to receive a food product and comprises a porous structure allowing heated cooking oil to flow into the food product carrier.

Another example frying system comprises a frying chamber configured to hold a volume of heated cooking oil. The frying chamber may comprise a first end and second end defining a length of the frying chamber. The frying chamber may further comprise an internal conveyor. The frying system may further comprise an inlet at the first end, the inlet configured to introduce a food product carrier into the frying chamber. The internal conveyor may be configured to receive and horizontally translate the food product carrier through the volume of heated cooking oil along at least a subset of the length toward the second end.

In some embodiments, the food product carrier comprises: a bottom surface; a plurality of sidewalls arranged orthogonally to the bottom surface; and a plurality of voids in at least one of the bottom surface or the sidewalls. In some embodiments, the food product carrier comprises a top surface, wherein at least one of the bottom surface or the top surface is hingedly connected to one of the sidewalls to allow opening and closing of the carrier. In some embodiments, the frying system further comprises an external conveyor configured to advance the food product carrier toward the inlet.

In some embodiments, the frying system further comprises a stage platform positioned between the external conveyor and the inlet and configured to receive the food product carrier from the conveyor; and an actuator positioned adjacent to the stage platform and configured to advance food product carriers from the stage platform into the inlet. In some embodiments, the frying system further comprises a hopper configured to store a plurality of food product carriers and sequentially introduce the food product carriers onto the external conveyor.

An example method of frying food products may include directing a food product carrier containing a food product into a frying chamber via an inlet airlock, wherein the frying chamber contains a volume of heated cooking oil and the food product carrier comprises a food product. The method may further comprise horizontally translating the food product carrier through the frying chamber via an internal conveyor to direct the food product through the volume of heated cooking oil. The method may further comprise directing the food product carrier out of the frying chamber via an outlet airlock.

### BRIEF DESCRIPTION OF THE FIGURES

Having thus described the embodiments of the disclosure in general terms, reference now will be made to the accompanying drawings, which are not necessarily drawn to scale, and wherein:

FIG. 1 shows a perspective view of an example frying system in accordance with some embodiments of the present disclosure;

FIG. 2 shows a perspective view of an example frying system in accordance with some embodiments of the present disclosure;

FIG. 3 shows a perspective view of an example frying system in accordance with some embodiments of the present disclosure;

FIG. 4 shows a cross section of an example frying system in accordance with some embodiments of the present disclosure;

FIG. 5 shows a top view of an example frying system in accordance with some embodiments of the present disclosure;

FIG. 6A shows a perspective view of an example carrier in accordance with some embodiments of the present disclosure;

FIG. 6B shows a top view of an example carrier in accordance with some embodiments of the present disclosure;

FIG. 7A shows an example scenario of a batched frying sequence according to historical approaches;

FIG. 7B shows an example scenario of a sequential flow frying sequence in accordance with some embodiments of the present disclosure;

FIG. 8 shows an example loading sequence in accordance with some example embodiments of the present disclosure;

FIG. 9 shows an example unloading sequence in accordance with some example embodiments of the present disclosure;

FIG. 10 shows a perspective view of an example frying system in accordance with some embodiments of the present disclosure;

FIG. 11 shows a cross section of an example frying system in accordance with some embodiments of the present disclosure.

### DESCRIPTION

In general, various embodiments of the present disclosure provide improved systems for preparing cooked food products. For purposes of describing and illustrating exemplary aspects of the systems, the proceeding description is presented in the context of preparing fried food products. Within such context, the system is interchangeably referred to herein as a “flow pressure fryer” or “frying system.” It will be understood and appreciated that such context is provided by way of example and uses of the system in additional contexts, such as with grilling food products, are contemplated and within the scope of the invention.

Historical approaches to frying food products commonly use batch-based frying systems that operate in an open-air environment. For example, a quantity of food products may be collectively coated in a wash and breading, collectively fried in a volume of oil, and collectively extracted from the fryer. However, such approaches introduce several drawbacks and encounter challenges in meeting the efficiency, throughput, and cost minimization goals of QSRs. A first drawback may include inefficiencies introduced by batch-based approaches to the timely fulfillment of orders. For example, a quantity of orders for fried food may be received over a time interval of several minutes. However, the preparation of fried food products for each order may be delayed due to limitations in batch sizes, batch processing times, and/or the like. Consequently, a first-placed order may be fulfilled at the same time as a last-placed order, which reduces the efficiency and throughput of the QSR and potentially impacts customer satisfaction.

As another example drawback, the use of open air, batch-based frying systems may require multiple cycles of generating large quantities of heat, thereby imposing a significant energy cost to the QSR. Further, the heat and resultant steam may raise the temperature of the QSR and result in additional energy costs for offsetting the rises in temperature and venting the steam. In still another example, the collective frying of food products in a batch may result in uneven frying times and qualities amongst the food products. Further, the use of a stagnant oil volume may result in increasing oil quality degradation and temperature variation as successive batches are fried in the same oil.

To overcome these challenges, and others, the present disclosure provides an improved frying system that increases frying efficiency and consistency at least in part by sequentially processing a flowing stream of food products through a sealed, pressurized environment. In various embodiments, the system includes a single or dual airlocked frying chamber comprising an internal conveyor for transporting food products (or carriers comprising food products) through a recirculating volume of heated, pressurized oil. As used herein, “airlock” is intended to cover structures that prevent the passage of air, oil, steam, and/or the like from the frying chamber.

In various embodiments, the frying system more rapidly fries a quantity of food products as compared to batch-based frying systems commonly used in QSRs. As another example, the frying system may demonstrate greater energy efficiency due at least in part to the isolation of the cooking environment from the ambient atmosphere and continuous recirculation of oil through the internal chambers defining the cooking environment. In still another example, the frying system may increase time efficiency of pre-frying operations by enabling food products to be coated and fried on a continual basis as opposed to other approaches in which a batch of products are coated collectively and must await completion of an in-progress batch to begin frying. These advantages, and others, shall be made further apparent in the proceeding description of example embodiments of the frying system and the illustrations thereof provided in the accompanying figures.

### Example Frying System

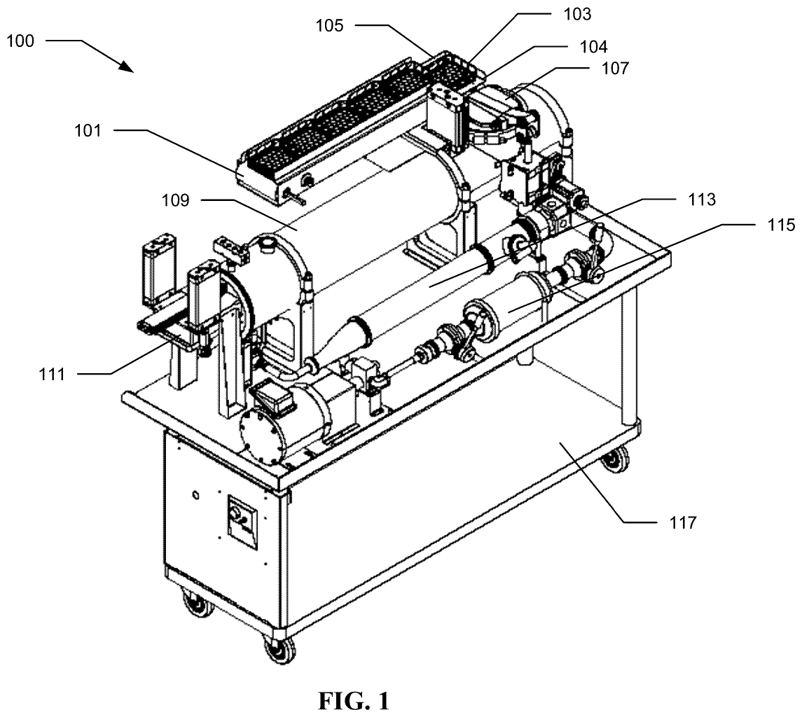

FIG. 1. shows a perspective view of an example frying system 100. In various embodiments, the frying system 100 is configured to receive and sequentially fry food products. In some embodiments, the frying system 100 advances individual food products through a sequential flow frying process. For example, a plurality of food products may be fed through the frying system 100 in succession to sequentially fry the food products. In some embodiments, the frying system 100 is configured to mechanically translate and submerge food products through a volume of heated oil within an internal frying chamber. In some embodiments, individual food products are received into respective carriers 103 (also referred to herein as “food product carriers”). In some embodiments, the frying system 100 is configured to mechanically translate carriers 103 comprising individual food products through a sequential flow frying process. For example, a plurality of carriers 103 may be fed through the frying system 100 in succession to sequentially fry a plurality of food products. In various embodiments, the frying system 100 and flow frying techniques overcome historical challenges and drawbacks associated with batch-based frying approaches. For example, as compared to batch-based approaches, the frying system 100 may reduce per-unit and overall cook times, increase cook efficiency, and improve consistency of textures and flavors across the fried products.

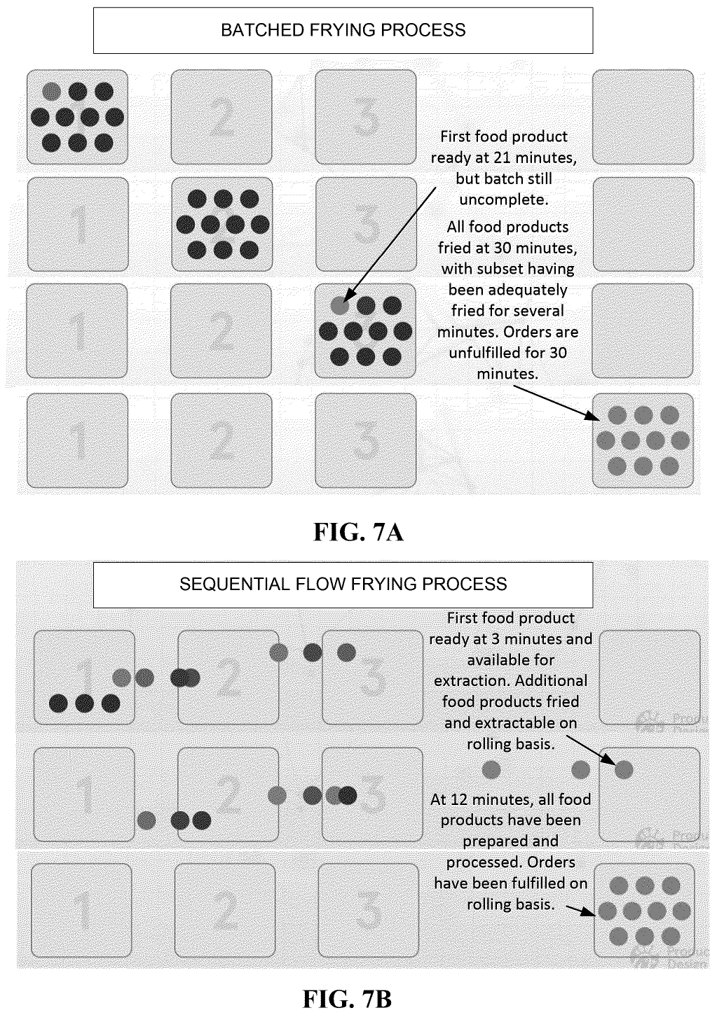

In an example scenario of batch-based frying (see FIG. 7A), a QSR may receive a set of orders requiring preparation of ten fried food products in total. The batch-based approached (e.g., performed using a conventional basket and drop-in fryer) may require 30 total minutes to prepare the ten fried food products. In such contexts, an individual food product may require 21-30 minutes to achieve adequate frying due to variances in oil temperature and physical arrangement within the batch. While a first food product may be fully fried at 21 minutes, the entire batch must remain in the fryer until all food products have reached an adequate frying level. As a result, the batch-based approach may present drawbacks of order preparation inefficiency and inconsistent food texture and flavor. For example, a QSR may be prevented from fulfilling a plurality of orders until a batch of fried food products is completed. As another example, the dependency of individual and collective frying times on the last-to-fry product in the batch may result in over-frying of at least a portion of the batched products.

In addition, this hypothetical assumes that a full batch of ten food products has already been ordered by customers. For fewer than ten orders, the cook cycle can take almost as long and will cause orders that are placed during the cook cycle to wait even longer before beginning. Alternatively, the QSR manager or cook could place more than the ordered number of food products into the first batch on the hope that an order will come in during the cook cycle. But this requires unnecessary estimation and possible waste of food if such orders are not received.

In an example scenario of sequential flow frying (see FIG. 7B), the QSR may place ten food products into respective carriers 103. The carriers 103 may be advanced sequentially through the frying system 100 at 1-minute separation intervals. The frying system 100 may achieve an individual frying time of 3 minutes and, as a result, a total processing time of 12 minutes for all ten food products. In doing so, the frying system 100 may demonstrate greater time efficiency as compared to the batch-based approach. Further, the fried food products may be immediately retrievable from the frying system 100 upon reaching the desired fry time. In this manner, the frying system may improve order fulfillment efficiency as compared to the batch-based approach in which order fulfillment must await completion of an entire batch of fried products. For example, the first customer's order for a food product could be fulfilled before well before the time required to cook a full batch. Additionally, the frying system 100 may subject each food product to the same frying time and oil temperature due to the isolation of the food products from one another during frying. In this manner, the frying system 100 may overcome the challenge of ensuring consistent flavor, texture, and serving temperature across the orders.

It will be understood that the above scenarios and accompanying FIGS. 7A and 7B are provided by way of example, and other timing parameters, product quantities, and/or the like may be utilized in accordance with the described techniques without departing from the spirit and scope of the present disclosure.

In some embodiments, the frying system 100 is attached atop a cart 117. The cart 117 may enable repositioning of the frying system 100 within a QSR kitchen. For example, whereas historical frying systems may be installed in a fixed location within a kitchen, the frying system 100 may be more readily deployed, moved, and stored dependent on needs of the QSR restaurant. In some embodiments, a plurality of frying systems 100 are deployed at a QSR and may be utilized on a dynamic basis to scale the frying capacity of the QSR to order demands. In some embodiments, a respective frying system 100 is associated with frying a particular food product type. For example, a first frying system 100 may be configured to fry filets, a second frying system 100 may be configured to fry tenders or strips, and a third frying system 100 may be configured to fry nuggets. The configuration of a frying system 100 according to a target food product may include adjusting cooking oil temperature, carrier movement rate, carrier size, and/or the like.

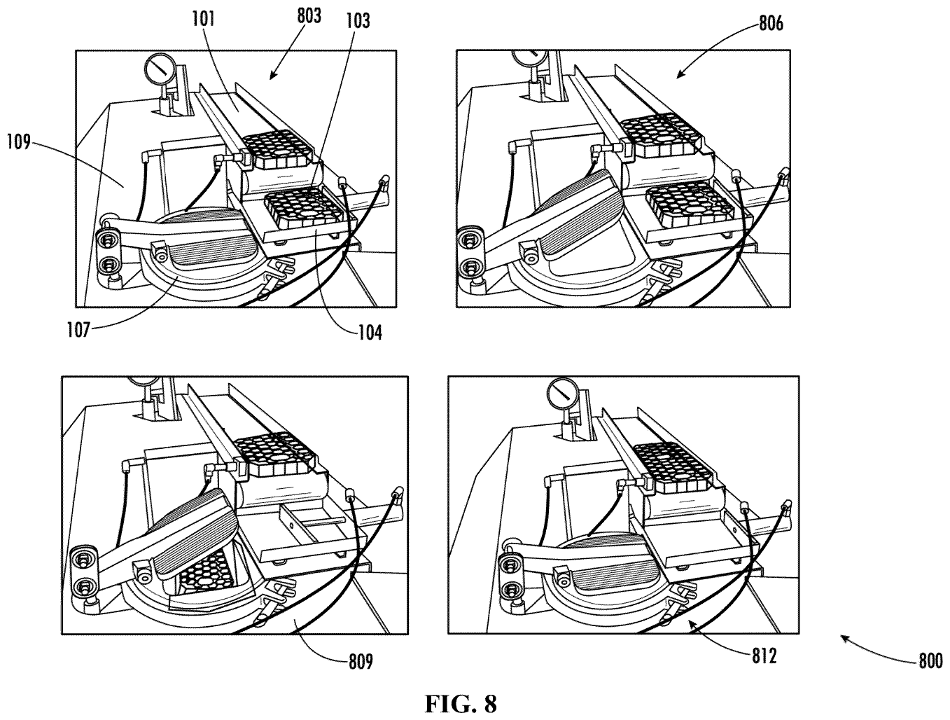

In some embodiments, a frying system 100 includes a conveyor 101 (also referred to as an “external conveyor”) configured to translate carriers 103 toward an input of a frying chamber 109. For example, as shown in operation 803 of the loading sequence 800 of FIG. 8, the conveyor 101 may advance a carrier 103 toward an input of the frying chamber 109. In various embodiments the conveyor 101 comprises or is connected to a hopper configured to store a plurality of food product carriers, enabling carriers 103 to be sequentially introduced to the conveyor 101. For example, a hopper may comprise multiple carriers 103, each comprising a food product. The hopper may be configured to automatically dispense a carrier 103 onto the conveyor 101 in response to a command, activation of the conveyor 101, and/or the like. In some embodiments, the input of the frying chamber 109 includes an inlet airlock 107. In some embodiments, the frying system 100 includes a stage platform 104 onto which the conveyor 101 may advance a carrier 103 (see operation 803 shown in FIG. 8).

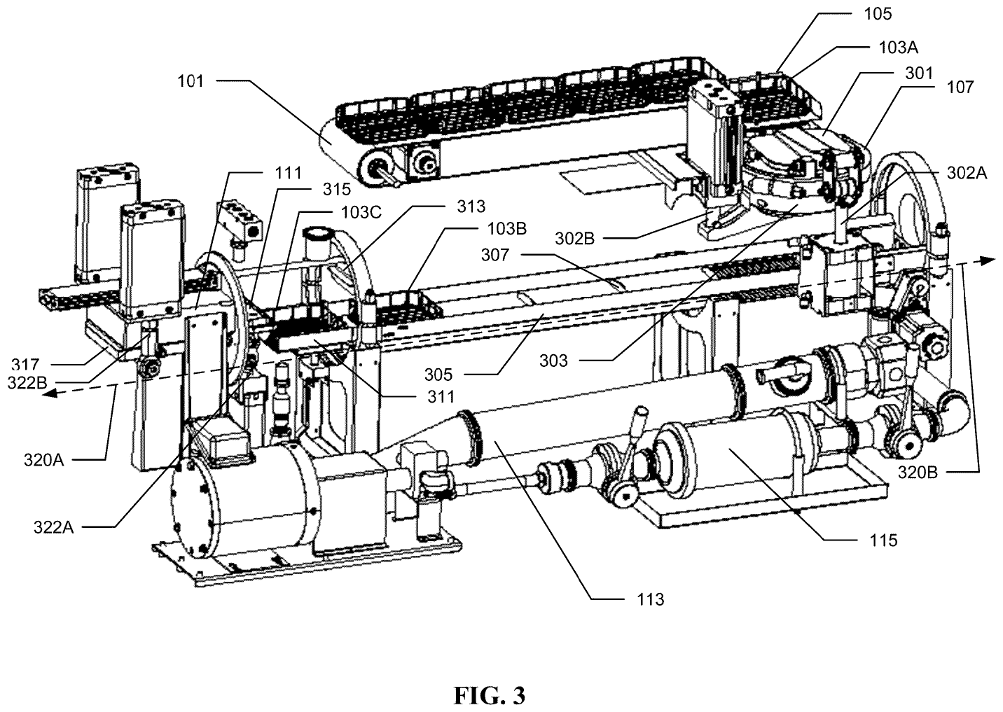

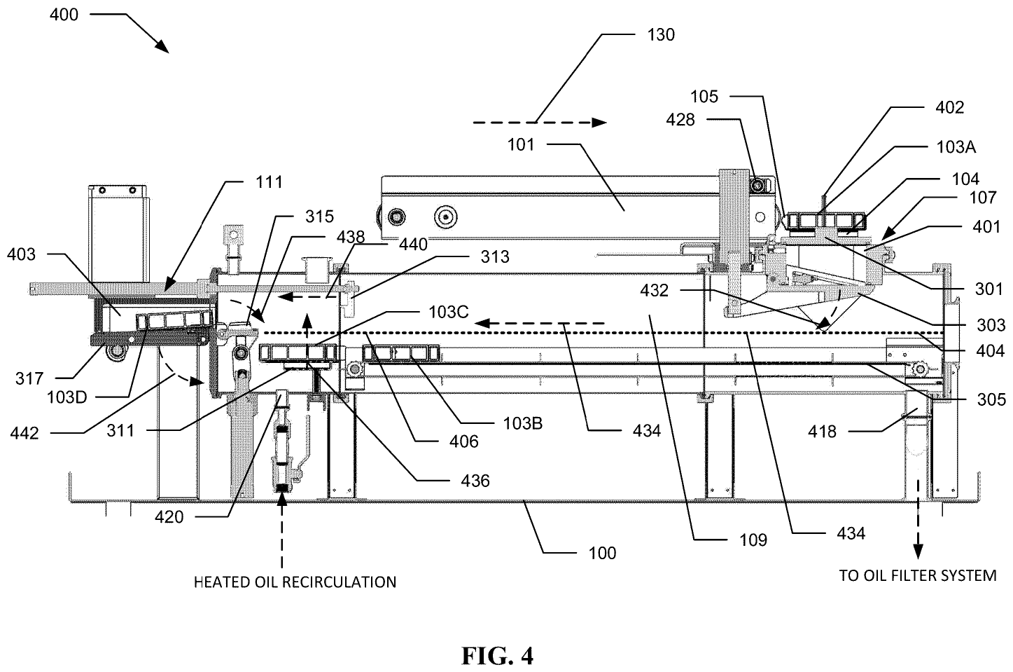

In some embodiments, the inlet airlock 107 includes a first door 301 (see FIGS. 3 and 4) configured to open and, in doing so, expose an inlet chamber 401 (see FIG. 4). In some embodiments, in response to advancement of a carrier 103 onto the stage platform 104, the first door of the inlet airlock 107 may open to the external environment. For example, as shown in operation 806 (FIG. 8), the first door of the inlet airlock 107 may rotate from a closed state to an open state in response to advancement of a carrier 103 onto the stage platform 104. In some embodiments, the frying system 100 includes an actuator 105 configured to push a carrier 103 from the stage platform 104 into the airlock chamber exposed via the opening of the first door of the inlet airlock 107. For example, as shown in operation 809 (FIG. 8), the actuator 105 may contact and direct the carrier 103 off the stage platform 104 into the airlock chamber in response to the opening of the first door. In some embodiments, the first door is configured to close and seal the inlet airlock 107 in response to advancement of a carrier 103 into the airlock chamber. For example, as shown in operation 812 (FIG. 8), the first door of the inlet airlock 107 may rotate from the open state to the closed state in response to receipt of a carrier 103 into the airlock chamber. In some embodiments, the inlet airlock 107 includes a second door 303 (see FIGS. 3 and 4) configured to transition from a closed state to an open state to deposit a carrier 103 into the frying chamber 109. For example, the second door of the inlet airlock 107 may rotate from the closed state to the open state to cause a carrier 103 deposited thereon to slide onto an internal conveyor within the frying chamber 109.

In various embodiments, the inlet airlock 107 is configured to pressurize the atmosphere of the airlock chamber to a cooking pressure present within the frying chamber 109. For example, in response to advancement of a carrier 103 into the inlet airlock 107 and transition of the first airlock door to the closed state, the second door of the inlet airlock 107 may open such that the pressures of the inlet airlock 107 and frying chamber 109 become equalized.

In various embodiments, the transition of the second door of the inlet airlock 107 the closed state to the open state causes the carrier 103 to be deposited onto an internal conveyor within the frying chamber 109. In response to release of the carrier 103 from the inlet airlock 107, the second door may transition from the open state to the closed state. Following the retransition of the second door to the closed state (and while the first door remains in the closed state), the chamber within the inlet airlock 107 may be depressurized to ambient levels such that the first door may be reopened and a subsequent carrier 103 deposited into the inlet airlock 107. In some embodiments, depressurizing the inlet airlock 107 (or outlet airlock 111) includes venting steam from the airlock chamber via one or more exhaust lines. In some embodiments, the frying system 100 is configured to vent steam into the QSR. The volume of vented steam may be significantly lower than steam released to the QSR environment in batch-based approaches. As a result, the frying system 100 may contribute less to rises in QSR temperature as compared to batch-based approaches. In doing so, the frying system 100 may improve energy efficiency of the QSR by reducing reliance on cooling methods, such as heating, ventilation, and air condition (HVAC) systems. Additionally, or alternatively, in some embodiments, the frying system 100 is configured to vent steam outside of the QSR. In doing so, the frying system 100 may eliminate or significantly curb rises in internal restaurant temperature caused by conventional frying operations.

In some embodiments, the frying chamber 109 is configured to hold a volume of heated cooking oil. In some embodiments, the pressure within the frying chamber 109 rises due to the heat. In various embodiments, the frying chamber 109 is configured to tolerate a threshold elevated pressure (e.g., as measured relative to ambient pressure). For example, the frying chamber 109 may be configured such that the heated oil may elevate the internal pressure to 12 PSI, or another suitable value. Alternatively, or additionally, in some embodiments, the frying chamber 109 is connected to an external pressurization system configured to maintain a cooking pressure within the frying chamber 109. For example, the frying chamber 109 may be mechanically pressurized to 12 PSI, or another suitable value, via a positive pressure pump, compressor, and/or the like. In various embodiments, the frying chamber 109 includes one or more pressure regulation mechanisms (e.g., pressure relief valves, and/or the like) configured to vent excess pressure from the frying chamber 109. In some embodiments, the frying chamber 109 is configured to vent the internal atmosphere of the frying chamber 109 to maintain a target pressure within the frying chamber 109, within the volume of heated oil, and/or the like. For example, the frying chamber 109 may conditionally vent steam to maintain consistent pressure within the frying chamber 109, the volume of heated oil, and/or the like. In some embodiments, an internal atmosphere of the frying chamber 109 comprises ambient air. In other embodiments, the internal atmosphere may exclude ambient air and comprise one or more inert gases including nitrogen, carbon dioxide, argon, and/or the like.

In various embodiments, within the frying chamber 109 the frying system includes an internal conveyor configured to receive and advance carriers 103 through the frying chamber 109. In some embodiments, the internal conveyor advances a carrier 103 from a first end of the frying chamber 109 proximate the inlet airlock 107 to a second end of the frying chamber 109 proximate to an outlet airlock 111. For example, the frying system 100 may include an internal conveyor 305 (see FIGS. 3 and 4) configured to transport carriers 103 through the volume of cooking oil between the inlet airlock 107 and the outlet airlock 111.

In some embodiments, the frying system 100 includes a heating system 113 configured to heat the oil to ensure cooking temperatures remain within desired ranges. For example, the heating system 113 may receive oil from the frying chamber 109, heat the oil via one or more thermal elements, and recirculate the oil into the frying chamber 109. In some embodiments, the frying system 100 includes a filtration system 115 configured to filter oil from the frying chamber 109 to remove particulates, impurities, and/or the like. In some embodiments, the filtration system 115 is connected to the frying chamber 109 and heating system 113 such that the filtration system 115 may receive and filter oil from the frying chamber 109 and circulate the filtered oil through the heating system 113 for thermal processing prior to reintroduction of the filtered, heated oil into the frying chamber 109.

In some embodiments, the outlet airlock 111 includes a first door configured to transition from a closed state to an open state to enable receipt of a carrier 103 into the airlock. For example, the outlet airlock 111 includes a first door 315 (see FIGS. 3 and 4) that may rotate from a closed state to an open state to expose an outlet chamber 403 to the frying chamber 109. In such contexts, the transition of the first door to the open state may cause pressurization of the outlet chamber 403 in accordance with the pressurization of the frying chamber 109. As further described herein, a carrier 103 may be advanced into the outlet airlock 111 and the first door transitioned to the closed state. Following reclosure of the first door, the outlet airlock 111 may be depressurized to ambient levels. In various embodiments, the outlet airlock 111, inlet airlock 107, and/or the like include valved vent lines that extend from the respective airlock to an environment external to the QSR such that steam may be vented outside the QSR.

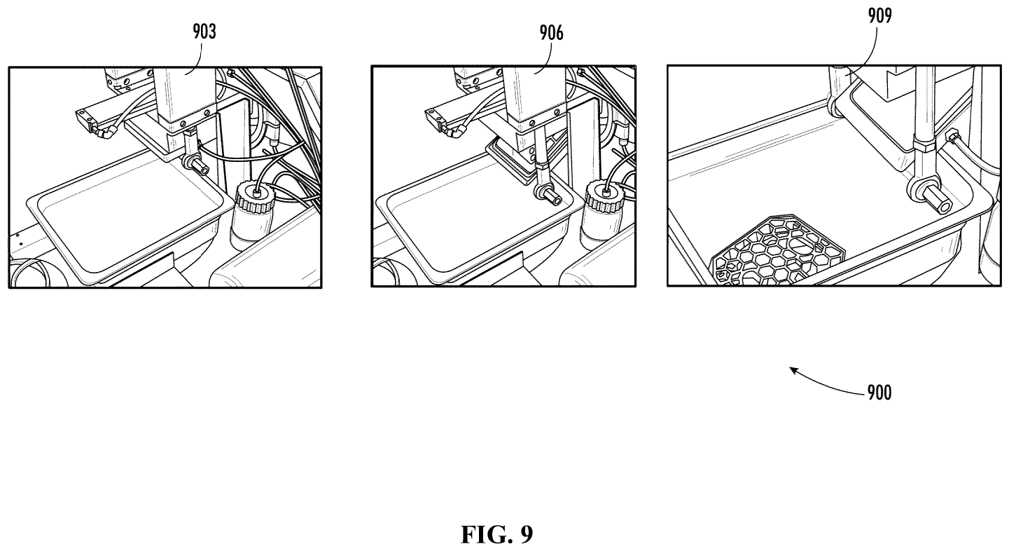

In some embodiments, following depressurization of the outlet airlock 111, the second door is transitioned from the closed state to an open state to dispense the carrier 103 and fried food product therewithin out of the frying system 100. For example, as shown in operations 903-909 of the unloading sequence 900 of FIG. 9, the second door of the outlet airlock 111 may be rotated downward to cause the carrier to advance from the outlet airlock 111 onto a collection tray and/or the like.

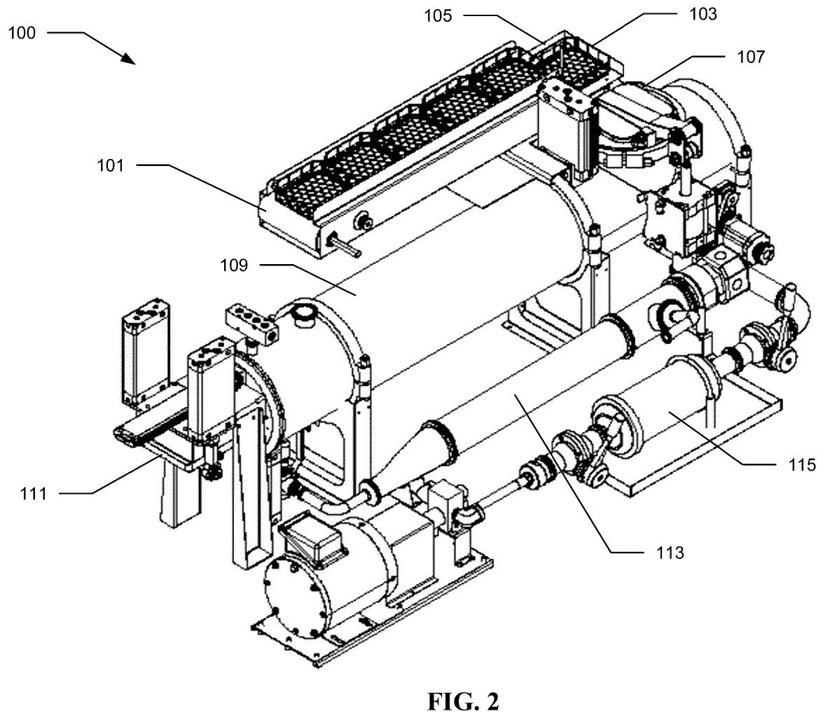

FIG. 2 shows a perspective view of the frying system 100. In some embodiments, the frying system 100 is installed on a stationary structural element of a QSR kitchen. For example, the frying system 100 may be attached via brackets, screws, and/or the like to a floor, ceiling, counter, and/or the like of a QSR restaurant. In various embodiments, the frying system 100 demonstrates a reduced spatial footprint as compared to batch-based fryers commonly utilized by QSRs. For example, the frying system 100 may demonstrate a lower spatial footprint as compared to drop-in, basket-based fryers because some embodiments herein don't require manual access to the top of the frying system by cooks. For example, the conveyor 101 may be configured to deliver carriers from a floor level to an elevated frying system mounted closer to the ceiling. Upon leaving the frying system, the cooked carriers can then slide down a chute or the like (not shown) back to the floor level. In some embodiments, a plurality of frying systems 100 are installed in a QSR kitchen in a row or stacked column arrangement, which may provide additional efficiencies in utilization of kitchen space and throughput of frying operations.

In some embodiments, the enclosed cooking environment of the frying system 100 reduces heat waste of the frying process and results in lower steam generation as compared to exposed air frying systems. For example, drop-in, basket-based fryers may lose significant heat to ambient air within the QSR kitchen. As a result, additional energy may be required to maintain the same oil temperatures in the conventional fryer as compared to energy required to maintain oil temperatures within the enclosed environment of the frying system 1000. Additionally, the exposure of heated oil to the ambient environment may undesirably increase the temperature of the QSR kitchen and potentially require counteracting HVAC energy expenditures to cool and/or dehumidify the QSR kitchen. In contrast, the frying chamber 109 may confine heated oils, gases, and/or the like to sealed pipes and chambers, thereby reducing the energy cost and temperature impact of frying processes. Further, heated steam and/or the like may be vented out of the QSR, which may circumvent traditional energy costs associated with offsetting the rises in temperature caused by conventional fryers.

In some embodiments, in comparison to other pressure-based frying systems, the frying system 100 demonstrates greater energy efficiency in the maintenance of cooking pressures. For example, common approaches to pressure cooking include loading food products into the pressurization vessel and gradually raising the temperature of the pressurization vessel to achieve the desired pressure. In such approaches, the pressure must be vented following the cooking process to enable retrieval of the cooked food products. In such contexts, the cycle of repressurizing a large cooking volume may result in high energy usage and reduced time efficiency. In contrast, the inlet airlock 107 and outlet airlock 111 of the frying system 100 may enable the cooking portion of the frying system 100 (e.g., frying chamber 109) to remain constantly pressurized throughout cooking operations. For example, whereas other pressurized frying systems may depressurize and repressurize between per-product or per-batch frying operations, the frying chamber 109 may remain pressurized throughout input, frying, and output of food products. In this manner, the disclosed frying systems and techniques may obtain additional energy savings and increased time efficiency.

FIG. 3 shows a perspective view of the frying system 100. For purposes of showing and describing internal components and additional aspects of the frying system 100, the illustration in FIG. 3 omits the encasement that defines the frying chamber 109. This encasement may be configured as cylinder of circular or other cross sections, and may be formed of multiple sections bolted and sealed together.

In various embodiments, the inlet airlock 107 includes a first door 301 and a second door 303. In some embodiments, the first door 301 is configured to transition between a closed state and an open state. In some embodiments, the frying system 100 includes an actuator 302A connected to the first door 301 and configured to transition the first door 301 between the open and closed states. In the closed state, the first door 301 may seal the inlet airlock 107 from the ambient environment. In the open state, the first door 301 may expose the inlet airlock 107 to the ambient environment such that a carrier 103A (and a food product contained therein) may be advanced into the inlet airlock 107.

In some embodiments, the second door 303 is configured to transition between a closed state and an open state. In some embodiments, the frying system 100 includes an actuator 302A connected to the first door 301 and configured to transition the first door 301 between the open and closed states. In the closed state, the second door 303 may seal the inlet airlock 107 from the pressurized environment within the frying chamber. In the open state, the second door 303 may cause a deposited carrier to advance from the inlet airlock 107 onto an internal conveyor 305. In some embodiments, the first door 301 and second door 303 are configured to their respective closed states to enable depressurization of the inlet airlock 107.

In some embodiments, the internal conveyor 305 extends along a longitudinal axis of the frying chamber (indicated by a direction line 320A, 320B). In some embodiments, the internal conveyor 305 extends along the frying chamber underneath the inlet airlock 107 and further to a portion of the frying chamber extending behind the inlet airlock 107. The second door 303 may comprise an internal surface configured to receive and support a carrier. The second door 303 may be configured to transition to the open state by rotating such that the carrier may advance downward and rearward from the inlet airlock 107 onto the portion of the internal conveyor 305 that extends behind the inlet airlock 107. By doing so, the internal conveyor 305 may accommodate an additional index for receiving a carrier without requiring elongation of the frying chamber. In this manner, the frying system 100 may further demonstrate improved spatial efficiency in comparison to typical QSR fryers.

In some embodiments, the belt of the internal conveyor 305 is porous such that oil within the frying chamber may flow through the belt, and may be formed of any material capable of withstanding the heated oil and pressures within the frying system, such as a stainless steel linked chain belt. For example, the belt may include a plurality of slots, holes, and/or the like that permit passage of oil through the belt. The porosity of the belt may reduce the friction of movement through the volume of oil within the frying chamber. Additionally, the porosity may reduce the buildup of particles, residue, and/or the like along the internal conveyor 305. For example, excess coating, breading, crumbs and/or the like may pass freely through the porous belt into the surrounding oil and, further, into one or more filtration systems configured to isolate materials from the oil supply.

In various embodiments, the internal conveyor 305 includes a plurality of dividers 307 that partition the belt of the internal conveyor 305 into segments. A respective segment may embody a region of the belt that is configured to accommodate a desired quantity of carriers. For example, the dividers 307 may partition the belt into a plurality of segments that are each configured to accommodate a single carrier. In some embodiments, the dividers 307 ensure equal spacing and timing between a sequence of carriers deposited onto the internal conveyor 305. In some embodiments, the bottom of the frying chamber is configured in a sloped orientation such that fluid flow under gravity is directed toward an inlet of the filtration system 115. The sloped orientation of the bottom of the frying chamber may concentrate particles, residue, impurities, and/or the like toward the filtration system 115. In doing so, the sloped orientation of the frying chamber may improve filtration efficiency and increase purity of the cooking oil. A sump (not shown) may be provided adjacent the inlet of the filtration system 115, and an access door may be provided in the sump for periodic manual cleaning of any sludge or remaining cooking residues that are not drawn into the filtration system 115. In some embodiments, the frying chamber 109 includes a wiper mechanism (not shown) configured to translate along the length of the frying chamber 109 and direct sludge, cooking residues, and/or the like into the sump or inlet of the filtration system 115. For example, the dividers 307 may include silicon wipers and be configured to a height such that the wipers contact a bottom surface of the frying chamber 109 and scrape sludge, cooking residues, and/or the like toward a sump or inlet of the filtration system 115.

The internal conveyor 305 may demonstrate a slope and, in such contexts, the dividers 307 may ensure that the carriers deposited to the belt advance smoothly against a downward slope or with an upward slope. For example, in some embodiments, the internal elevator discussed below may be eliminated if the conveyor is provided with an upward slope out of the cooking oil towards the outlet airlock 111. The dividers 307 and/or the internal conveyor 305 may be provided with magnets, clips or the like to securely but releasably hold the carriers in the correct place on the internal conveyor 305. The individual carriers could be similarly provided with magnets, clips or the like. In embodiments, this not only promotes an even spacing of the carriers, but can prevent buoyancy of the food products in the oil (even within carriers) from floating away from the internal conveyor 305.

In some embodiments, the frying system 100 includes an internal elevator 311 configured to receive a carrier from the internal conveyor 305 and remove the carrier from heated oil. For example, the internal conveyor 305 may advance a carrier 103C (and food product arranged therein) onto a surface of the internal elevator 311. In various embodiments, the internal elevator 311 is configured to raise upward to position the deposited carrier in alignment with the outlet airlock 111. In a lowered state, the elevator 311 may be submerged below an oil level of the frying chamber. For example, in the lowered state, the receiving surface of the elevator 311 may be positioned below an oil level 430 (see FIG. 4) and level with, or slightly below, a top surface of the belt of internal conveyor 305.

In some embodiments, the outlet airlock includes a first door 315 configured to transition between a closed state and an open state. In some embodiments, the frying system 100 includes an actuator 322A that transitions the first door 315 between the closed and open states. In the closed state, the first door 315 may seal the outlet airlock 111 from the frying chamber. In the open state, the first door 315 may be rotated to a horizontal position such that the outlet airlock 111 is exposed to the frying chamber. Additionally, in the open state, the horizontal position of the first door 315 may be in alignment with the raised position of the internal elevator 311. For example, in the open state, an internal surface of the first door 315 and a surface of the interval elevator 311 may lie within a horizontal plane extending in the longitudinal direction.

In some embodiments, the frying system 100 includes a retrieval mechanism 313 configured to advance the carrier from the internal elevator 311 into the outlet airlock 111. In some embodiments, the retrieval mechanism 313 includes an actuator connected to a rod. The rod may extend above and over the internal elevator 311 and deposited container. The rod may include a vertically oriented end plate configured to catch and advance carrier toward the outlet airlock 111 upon retraction of the rod via the actuator. For example, following raising of the internal elevator 311, the first door 315 may rotate downward to an open state and the retrieval mechanism 313 may retract the rod to draw the end surface of the rod against the carrier such that further retraction of the rod causes the carrier to advance over the first door 315 into the outlet airlock 111. In some embodiments, the carrier is advanced onto a surface of a second door 317 of the outlet airlock 111 (e.g., the second door 317 being configured to a closed state). In some embodiments, following the advancement of the retrieval mechanism 313, the first door 315 transitions to the closed state to seal the carrier within the outlet airlock 111.

In various embodiments, the outlet airlock 111 includes a second door 317 configured to transition between a closed state and an open state. In some embodiments, the frying system 100 includes an actuator 322B configured to transition the second door 317 between the open and closed states. In the closed state, the second door 317 may seal the outlet airlock 111 from the external environment such that the internal volume may be depressurized to ambient levels via venting of steam from the airlock chamber into the QSR and/or to one or more exhaust lines configured to release steam outside the QSR. In the open state, the second door 317 may cause the dispensing of a carrier from the outlet airlock 111. In some embodiments, in the closed state, the second door 317 defines a horizontal surface configured to accommodate a carrier. In the open state, the second door 317 may rotate to a sloped orientation such that the carrier advances downward out of the outlet airlock 111. This slope advantageously allows the carrier to slide out of the frying system without the need for further actuators or human contact.

FIG. 4 shows a cross-section 400 of the frying system 100. In various embodiments, the conveyor 101 is configured to translate carriers in a first direction (indicated by arrow 130) onto the stage platform 104. In some embodiments, the frying system 100 includes one or more computing devices configured to control activation of the conveyor 101. The computing device may engage the conveyor 101 at a programmed frequency to initiate the frying process. For example, a plurality of carriers may be loaded onto the conveyor 101, a respective carrier having a coated food product carried therein or thereon. The computing device may activate the conveyor 101 at preset intervals to advance the carriers toward and onto the stage platform 104.

In some embodiments, the frying chamber 109 is filled with heated oil to an oil level 430. In some embodiments, the oil level 430 is configured such that carriers deposited onto the internal conveyor 305 are fully submerged throughout their advancement along the conveyor belt. Further, the oil level 430 may be configured such that a respective carrier is positioned out of the volume of oil when the carrier rests atop the elevator 311 and the elevator is configured to a raised position. In some embodiments, the frying system 100 is configured to adjust the oil level 430 based on one or more factors including the type of food product being fried, a current or future planned quantity of food products within the frying chamber 109, and/or the like. For example, the oil level 430 may be raised when a frying system 100 processes filets and lowered when a frying system 100 is processing tenders, nuggets, and/or the like. As another example, the oil level 430 may be lowered or raised in response to an increase or decrease in the quantity of carriers within the frying chamber 109. In some embodiments, the frying chamber 109 includes one or more level control systems configured to detect the oil level 430 and adjust the volume of oil within the frying chamber based on the detected level. For example, the frying chamber 109 may include a capacitive level control system configured to maintain a constant oil level 430 or adjust the oil level 430 based one or more factors (e.g., food product type, quantity, and/or the like).

In some embodiments, the frying system 100 includes one or more sensors 402 configured to detect advancement of a carrier onto the stage platform 104. For example, the sensor 402 may detect that a carrier 103A is positioned atop the stage platform 104. In some embodiments, the sensor 402 includes an optical sensor, pressure sensor, linear hall effect sensor, inductive proximity sensor, and/or the like. In some embodiments, in response to the sensor 402 detecting a carrier on the stage platform 104, the inlet airlock 107 is vented to ambient pressure (e.g., the first door 301 and second door 303 being configured to their respective closed states). In some embodiments, in response to depressurization of the inlet airlock 107 and advancement of a carrier onto the stage platform 104, the first door 301 transitions to an open state to expose an inlet chamber 401 of the inlet airlock 107. In some embodiments, in response to the first door 301 transitioning to the open state, the actuator 105 extends to push the carrier from the stage platform 104 into the exposed inlet chamber 401. In some embodiments, the actuator 105 is disabled from extending while the first door 301 is configured to the closed state. In some embodiments, the inner surface of the second door 303 embodies a bottom surface of the inlet chamber 401 such that the carrier may rest upon the inner surface upon advancement into the inlet chamber 401.

In some embodiments, the conveyor 101 includes one or more sensors 428 configured to detect that a carrier is in position at an end of the conveyor proximate to the stage platform 104. For example, the sensor 428 may comprise an inductive sensor configured to detect that a carrier is positioned at the end of the conveyor. In some embodiments, the conveyor 101 is configured to advance a carrier onto the stage platform 104 in response to i) the sensor 428 detecting advancement of a carrier to the end of the conveyor and ii) the sensor 402 detecting that the stage platform 104 is empty).

In various embodiments, in response to extension of the actuator 105 and/or detection of carrier advancement into the inlet chamber 401, the first door 301 transitions to the closed state and, in doing so, seals the inlet airlock 107 from the ambient environment. In some embodiments, in response to loading of the carrier and closure of the first door 301, the second door 303 transitions to an open state to expose the inlet chamber 401 to the frying chamber 109 and cause advancement of the carrier into the frying chamber 109. For example, the second door 303 may rotate downward in a direction indicated by arrow 432. In the open state, the inner surface of the second door 303 may be oriented at a downward slope. The repositioning and downward slope of the second door 303 may cause the carrier 103A to slide onto the internal conveyor within the frying chamber 109. As with the outlet airlock noted above, this slope advantageously allows the carrier to slide into the frying system without the need for further actuators or human contact. In some embodiments, the transition of the second door 303 to the open state causes pressurization of the inlet chamber 401 in accordance with the pressure of the frying chamber. In some embodiments, in response to reclosure of the second door 303, the inlet chamber 401 is vented to depressurize the inlet airlock 107 to ambient levels.

In various embodiments, the respective timings of airlock depressurization, door transition, belt advancement, and/or the like are controlled such that an index of the belt (e.g., a region between two dividers 307) is in position to receive the advancing carrier. In some embodiments, the oil level within the frying chamber 109 exceeds a height of the internal conveyor 305 such that the carriers and food products contained therein are fully submerged within the volume of oil throughout the frying process.

In various advancements, the internal conveyor 305 advances the carriers and respective food products contained therein through the volume of heated oil within the frying chamber 109. For example, the internal conveyor 305 may advance a carrier from a first end 404 of the frying chamber 109 to a second end 406 opposite the first end 404 in a direction indicated by arrow 434. As a carrier advances along the internal conveyor 305, the food product contained therein may undergo frying. For example, as a carrier 103B advances along the belt from the first end 404 to the second end 406, a food product within the carrier may be contacted and fried by the oil within the frying chamber. In some embodiments, the flow of oil over the food product increases an efficiency of thermal exchange between the oil and food product, which may reduce time required to fully fry the food product. In various embodiments, as compared to static frying approaches in which food products rest within a volume of oil, the advancement of food products through a volume of oil decreases the variation in oil temperature experienced by the food products. For example, in drop-in frying approaches, the temperature of the cooking oil may demonstrate local variations throughout its volume due to varied distances from heating elements, oil and thermal flow patterns, and the packing density of colder uncooked food products deposited into the oil may undesirably lower the temperature of the cooking oil for a period. In contrast, the present flow frying techniques and systems may move food products through a volume of heated, recirculating oil. In doing so, local deviations in oil temperature may be reduced, which may improve energy efficiency and ensure consistent cooking temperatures across the food products being fried.

In some embodiments, the internal conveyor 305 advances a carrier onto an elevator 311. The advancement of the carrier onto the elevator 311 may be timed to an interval in which the elevator 311 is configured to a lowered position. The elevator 311 may be configured to ascend and descend between raised and lowered positions in a direction indicated by arrow 436. In some embodiments, in response to advancement of a carrier onto the elevator 311, the elevator 311 transitions from the lowered position to a raised position. For example, the elevator 311 may ascend to a raised position such that a carrier 103C thereon is lifted into alignment with the outlet airlock 111. In some embodiments, in response to the transition of the elevator 311 to the raised position, the first door 315 of the outlet airlock 111 transitions to an open state (e.g., the second door 317 being configured to a closed state). For example, the first door 315 may rotate in the direction indicated by arrow 438. In some embodiments, the oil level within the frying chamber 109 is less than the height of the elevator 311 in the raised position. In this manner, the upwards translation of the carrier via the elevator 311 may remove the carrier and fried food product from the volume of oil within the frying chamber 109 and cause evacuation of excess oil from the carrier and fried food product. In some embodiments, the evacuation of oil from the food product may increase time efficiency of the QSR by automating the drainage operations commonly associated with final processing of fried food products.

In some embodiments, in response to the transition of the first door 315 to the open state, the retrieval mechanism 313 engages to pull the carrier into the outlet chamber 403 of the outlet airlock 111. For example, an actuator may retract a rod toward the outlet airlock 111 in a direction indicated by arrow 440. The rod may comprise a hooked portion configured to contact and advance a carrier into the outlet chamber 403 as the retract retracts. In some embodiments, in response to advancement of a carrier into the outlet chamber 403, the first door 315 transitions to the closed state. In doing so, the inner surface of the first door 315 may contact a remaining portion of the carrier that extends out of the outlet chamber 403 such that the remaining portion is advanced fully into the outlet chamber 403. In some embodiments, in response to scaling of the outlet airlock 111 via the closed states of the first and second doors 315, 317, the outlet chamber 403 is vented to ambient pressure.

In some embodiments, an inner surface of the second door 317 embodies a bottom surface of the outlet chamber 403. Upon advancement into the outlet chamber 403, the carrier may rest atop the inner surface of the second door 317. In some embodiments, in response to depressurization of the outlet chamber 403, the second door 317 transitions to an open state such that the inner surface is oriented at downward slope. For example, the second door 317 may rotate downward in a direction indicated by arrow 442. The downward orientation of the second door 317 may cause the carrier and fried food product contained therein to slide downwards out of the outlet airlock 111. For example, a carrier 103D may slide along the inner surface of the second door 317 and, in doing so, be dispensed from the outlet chamber 403. In various embodiments, a collection tray and/or the like is positioned proximate to the outlet airlock 111 such that carriers may be deposited onto the collection tray.

In various embodiments, the frying chamber 109 includes an oil outlet 418 configured to pass oil from the frying chamber 109 into a filtration system. In doing so, residues, particulates, impurities, and/or the like may be removed from the frying chamber 109 and isolated from the oil supply. In some embodiments, an outlet of the filtration system is connected to an inlet of a heating system such that filtered oil may be passed into the heating system prior to reintroduction to the frying chamber 109. In some embodiments, the frying chamber 109 includes an oil inlet 420 configured to receive heated oil outputted by the heating system. In some embodiments, the filtration and recirculation of heated oil throughout the frying system 100 improves frying efficiency and quality.

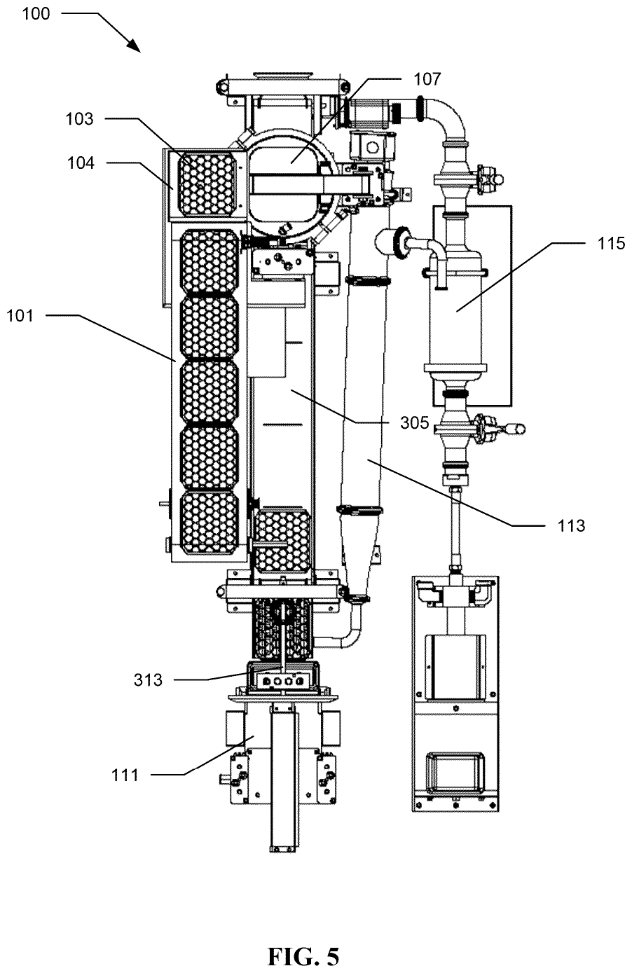

FIG. 5 shows a top view of an example frying system 100.

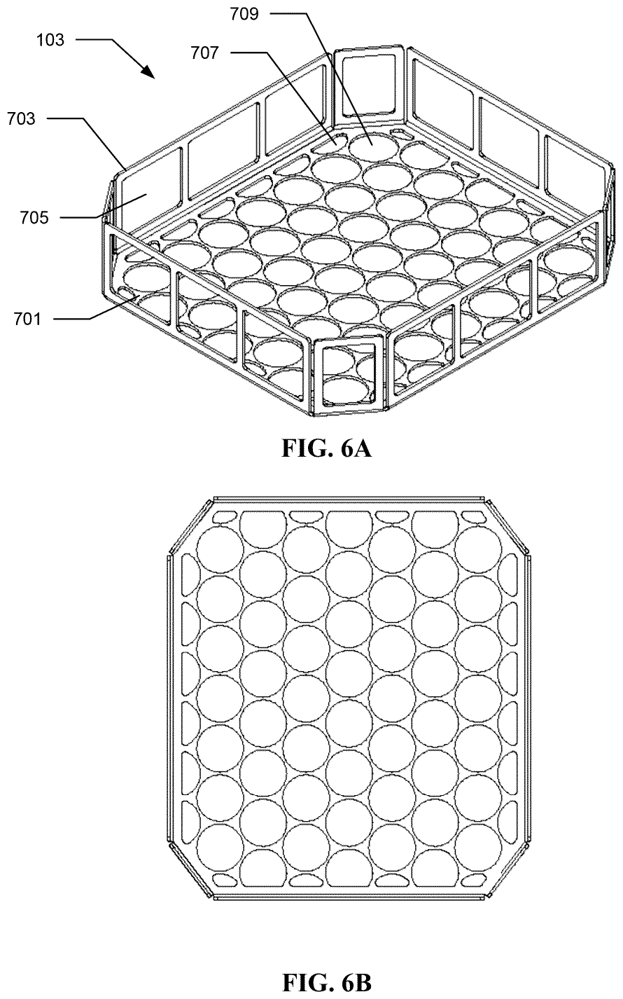

FIG. 6A shows a perspective view of an example carrier 103. In various embodiments, the carrier 103 is configured to receive a food product. In some embodiments, the carrier 103 is configured to hold the food product to facilitate movement of the food product through the frying system 100. In some embodiments, the carrier 103 is comprised of one or more materials that demonstrate a density in excess of a density of the cooking oil used within the frying system 100. In this manner, the carrier 103 may oppose buoyancy of the food product upon placement into the volume of oil within the frying system. As noted above, the carrier may be provided with magnets, clips or the like to releasably secure the carriers to the internal conveyor. In some embodiments, the carrier 103 comprises a bottom surface 701 and plurality of sidewalls 703 arranged orthogonally to the bottom surface 701. The bottom surface 701 and plurality of sidewalls 703 may be configured to receive a food product (e.g., a filet, tenders, nuggets, and/or the like) and hold the food product within the carrier 103 throughout the sequential flow frying processes described herein.

While not shown, the carrier 103 may further include a top surface. The sidewalls 703 may define a perimeter of the bottom surface 701 and top surface. In some embodiments, at least one of the bottom surface 701 or top surface includes a hinged connection to one of the sidewalls 703 such that the carrier 103 may be opened and closed to accommodate a food product. Alternatively, in some embodiments, at least one of the bottom surface 701 or top surface may be connected to a subset of the plurality of sidewalls 703 and biased towards an interior volume of the carrier 103. In this manner, the bottom surface 701 or top surface may be momentarily deflected outward to expose the interior of the carrier 103 for food product loading, after which the inward bias of the surface may prevent escape of the food product from the carrier 103 during processing.

In various embodiments, the carrier 103 includes high porosity such that oil may pass through carrier 103 and contact the food product. For example, the surfaces defining the carrier 103 may comprise various voids 705, 707, 709 through which oil may penetrate into the carrier interior. In some embodiments, the porosity of the carrier 103 reduces drag as the carrier 103 is advanced through the frying chamber 109 via the internal conveyor 305. In some embodiments, the porosity of the carrier 103 increases the efficiency of operations for draining excess oil from food products following frying.

FIG. 6B shows a top view of an example carrier 103. In some embodiments, the carrier 103 includes one or more interface features configured to enable engagement with the retrieval mechanism. For example, the top surface of the carrier 103 may include one or more engagement tabs, loops, or recessed areas positioned to receive corresponding hooks or clips of the retrieval mechanism, any of which may also be defined by the cage structure of the carrier 103. In some embodiments, the carrier 103 includes one or more ferromagnetic materials that enable a retrieval mechanism, such as an electromagnet, to magnetically couple to the carrier 103. Additionally, or alternatively, the carrier 103 may include one or more raised ridges or flanges extending from the top surface or sidewalls that may be grasped by mechanical clamps or grippers of a retrieval mechanism. In various embodiments, the bottom surface 701 includes one or more guide channels or alignment features that may interact with corresponding elements of the retrieval mechanism to ensure proper positioning during horizontal translation from the internal conveyor into the outlet chamber. The interface features may be configured to provide secure engagement during carrier movement while allowing for reliable release upon positioning within the outlet airlock.

FIG. 8 shows an example loading sequence 800 in accordance with some example embodiments of the present disclosure. The loading sequence 800 may illustrate example operations for introducing a carrier 103 into the frying system 100 through the inlet airlock 107. In various embodiments, at operation 803 the loading sequence 800 comprises advancing the carrier 103 onto the stage platform 104 positioned adjacent to the inlet airlock 107. In some embodiments, at operation 806, following the positioning of the carrier 103 on the stage platform 104, the first door 301 transitions from a closed state to an open state, thereby exposing the inlet chamber 401 to the external environment. In some embodiments, during the transition of the first door 301 to the open state, the second door 303 may remain in a closed state. The pressure within the inlet chamber 401 may be equalized to atmospheric pressure to facilitate safe loading of the carrier 103. In some embodiments, at operation 809 the input actuator 105 engages to advance the carrier 103 from the stage platform 104 into the exposed inlet chamber 401 of the inlet airlock 107. In various embodiments, at operation 812 the first door 301 transitions from the open state back to the closed state after the carrier 103 reaches its position within the inlet chamber 401. The closure may seal the inlet airlock 107 from the external environment. In some embodiments, the inlet chamber 401 may be pressurized to match the pressure within the frying chamber 109. Following pressurization, the second door 303 may transition to an open state to allow the carrier 103 to advance onto the internal conveyor 305 within the frying chamber 109.

In some embodiments, the frying system includes one or more position sensors configured to monitor the location and movement of carriers throughout the sequential flow frying process. The position sensors may be positioned at various points along the internal conveyor 305, inlet airlock 107, and outlet airlock 111 to track carrier advancement and ensure proper timing of operations. In some embodiments, the frying system is integrated with automated order processing systems of the QSR restaurant to receive real-time order data and adjust carrier introduction rates based thereon. The automated order processing integration may enable the frying system to anticipate demand fluctuations and optimize the feed rate of carriers into the inlet airlock 107, the frying chamber 109, and/or the like. In some embodiments, feed rate optimization algorithms analyze historical order patterns, current queue lengths, predicted demand, and/or the like to determine an optimal carrier introduction frequency. The frying system may dynamically adjust the timing intervals between carrier introductions to match the anticipated demand for fried food products, thereby reducing wait times for customers while minimizing food waste. In various embodiments, the combination of position sensing, automated order processing, and feed rate optimization may allow the frying system to operate at peak efficiency during varying demand periods throughout the day.

FIG. 9 shows an example unloading sequence 900 in accordance with some example embodiments of the present disclosure. The unloading sequence 900 illustrates example operations for removing a carrier 103 from the frying system 100 through the outlet airlock 111. In various embodiments, at operation 903 the unloading sequence 900 comprises positioning the carrier 103 within the outlet chamber 403 of the outlet airlock 111. In some embodiments, at operation 906, following the positioning of the carrier 103 in the outlet chamber 403, the carrier 103 progresses through the outlet airlock 111 as the system prepares for dispensing. In some embodiments, the frying system 100 depressurizes the outlet chamber 403 to match ambient pressure levels. In various embodiments, at operation 909 the second door 317 transitions from a closed state to an open state by rotating to create a downward slope, causing the carrier 103 to slide out of the outlet chamber 403 into the external environment.

In some embodiments, the frying system includes one or more position sensors configured to monitor the location and movement of carriers throughout the unloading sequence. The position sensors may be positioned at various points along the outlet airlock 111 to track carrier advancement and ensure proper timing of operations. In some embodiments, the frying system is integrated with automated order processing systems of the QSR restaurant to optimize the rate at which carriers and food products are output from the system. The automated order processing integration may enable the frying system to coordinate the unloading sequence with order fulfillment requirements. In various embodiments, output rate optimization algorithms analyze current queue status, order completion timing, and predicted demand to determine optimal carrier extraction timing. The frying system may dynamically adjust the timing intervals between carrier extractions to match the order fulfillment needs, thereby reducing wait times for customers while maintaining food quality and temperature.

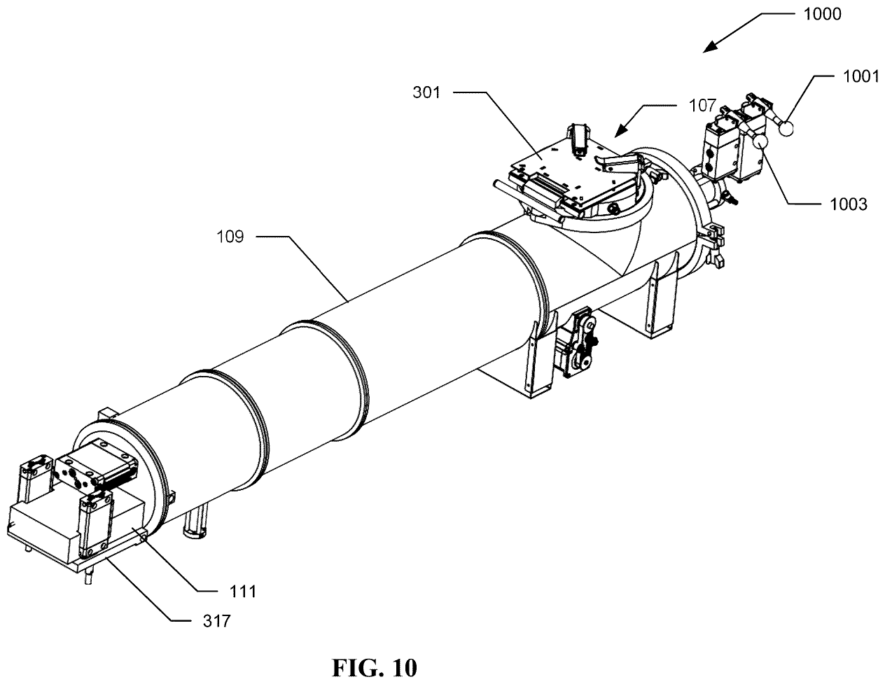

FIG. 10 shows a perspective view of the frying system 1000. In various embodiments, the frying system 1000 includes an inlet airlock 107 positioned at one end and an outlet airlock 111 positioned at an opposite end. The frying chamber 109 extends between the inlet airlock 107 and outlet airlock 111, providing a sealed environment for the frying process. In some embodiments, the inlet airlock 107 includes a first door 301 configured to control access to the inlet airlock 107 from the external environment. The outlet airlock 111 includes a second door 317 configured to control dispensing of carriers from the outlet airlock 111 to the external environment.

In various embodiments, the frying system 1000 includes one or more air directional control valves positioned near the inlet airlock 107. For example, the frying system 1000 may include a first air directional control valve 1001 and a second air directional control valve 1003 configured to regulate airflow, pressure, and/or the like, for one or more elements of the frying system. In some embodiments, the air directional control valves facilitate pressurization and depressurization operations of the inlet airlock 107 during carrier loading and unloading sequences. In doing so, the air directional control valves may enable precise control of pressure transitions to maintain the sealed environment of the frying chamber 109 while allowing sequential introduction of carriers. In some embodiments, the frying system 1000 includes other air directional control valves. For example, the frying chamber 109 may include one or more air directional control valves configured to vent air, steam, and/or the like from the frying chamber to maintain a target pressure within the chamber (e.g., counteracting pressure increases from raised temperatures within the chamber). As another example, the outlet airlock 111 may include one or more air directional control valves configured to facilitate pressurization and depressurization operations during carrier loading and unloading sequences.

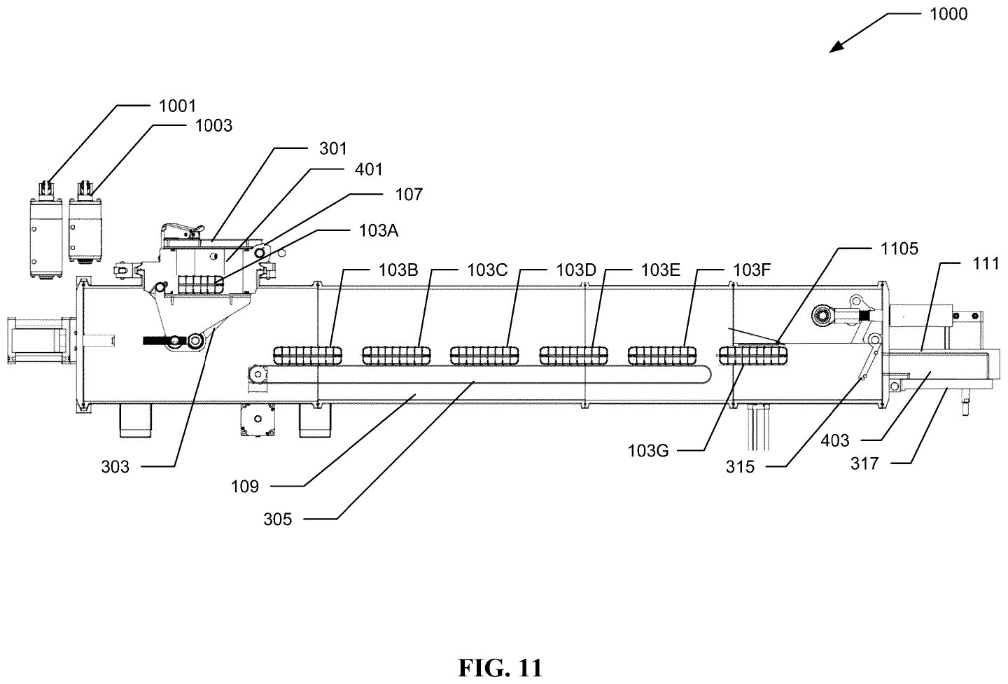

FIG. 11 shows a cross section of the frying system 1000. In various embodiments, the frying system 1000 includes an inlet airlock 107 comprising a first door 301 and a second door 303. The first door 301 and second door 303 define an inlet chamber 401 configured to receive carriers from the external environment and transfer the carriers into the frying chamber 109. In some embodiments, the first door 301 is configured to transition between a closed state sealing the inlet airlock 107 from the ambient environment and an open state exposing the inlet chamber 401 to the ambient environment. The second door 303 may be configured to transition between a closed state sealing the inlet airlock 107 from the frying chamber 109 and an open state exposing the inlet chamber 401 to the frying chamber 109. In some embodiments, the bottom surface of the inlet chamber 401 comprises the second door 303. The second door 303 may rotate to the open state to define a slope extending toward the internal conveyor 305, facilitating translation of the carrier from the inlet chamber 401 onto the internal conveyor 305.

In various embodiments, the frying system 1000 includes an internal conveyor 305 extending along a longitudinal axis of the frying chamber 109. The internal conveyor 305 may be configured to receive carriers from the inlet airlock 107 and advance the carriers through the volume of heated oil within the frying chamber 109. As shown in FIG. 11, the internal conveyor 305 may accommodate multiple carriers simultaneously during operation. For example, a first carrier 103A, second carrier 103B, third carrier 103C, fourth carrier 103D, fifth carrier 103E, sixth carrier 103F, and seventh carrier 103G may be positioned at different locations along the internal conveyor 305, demonstrating the sequential flow processing capability of the frying system 1000.

In some embodiments, the outlet airlock 111 includes a first door 315 and a second door 317. The first door 315 and second door 317 define an outlet chamber 403 configured to receive carriers from the frying chamber 109 and transfer the carriers to the external environment. In various embodiments, the first door 315 is configured to rotate upwards to transition between a closed state sealing the outlet airlock 111 from the frying chamber 109 and an open state exposing the outlet chamber 403 to the frying chamber 109. The second door 317 may be configured to transition between a closed state sealing the outlet airlock 111 from the external environment and an open state exposing the outlet chamber 403 to the external environment. In some embodiments, the bottom surface of the outlet chamber 403 comprises the second door 317. The second door 317 may rotate to the open state to define a slope extending toward the external environment, facilitating translation of the carrier out of the outlet chamber 403 and into the external environment (e.g., within which the carrier may be received onto a collection tray, external conveyor, and/or the like).

In various embodiments, the frying system 1000 includes a retrieval mechanism 1105 positioned proximate to the outlet airlock 111. In some embodiments, the retrieval mechanism 1105 comprises a lifter plate configured to engage with a top portion of a carrier to horizontally translate the carrier from the internal conveyor 305 into the outlet chamber 403. The lifter plate may be configured to contact and advance carriers in a controlled manner to facilitate transfer from the pressurized frying chamber 109 into the outlet airlock 111. For example, the lifter plate may be coupled to a track, actuator, and/or the like, by which the lifter plate may horizontally translate between the internal conveyor 305 and the outlet chamber 403. In some embodiments, the lifter plate includes one or more hooks configured to engage with corresponding features on the carrier, such as loops, tabs, or recessed areas formed in the carrier structure. The hooks may be spring-loaded or actuated to securely grasp the carrier during horizontal translation and release the carrier upon positioning within the outlet chamber 403. In some embodiments, the lifter plate comprises one or more electromagnets configured to magnetically couple with the carrier. The electromagnets may be selectively energized to attract and hold the carrier during translation and de-energized to release the carrier within the outlet chamber 403. In some embodiments, the lifter plate includes mechanical clips or clamps configured to engage with edges or protrusions of the carrier. The clips may be spring-biased to automatically engage with the carrier upon contact and may be actuated to release the carrier at the desired location. Alternatively, in some embodiments, the internal conveyor 305 extends to a region proximate the outlet chamber 403 such that carriers may be horizontally translated directly from the internal conveyor 305 into the outlet chamber 403.

While various aspects have been described, additional aspects, features, and methodologies of the claimed apparatuses will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

That which is claimed is:

1. A frying system comprising:
a frying chamber configured to hold a volume of heated cooking oil, the frying chamber comprising:
a first end and second end defining a length of the frying chamber; and
an internal conveyor configured to receive and horizontally translate a food product carrier through the volume of heated cooking oil along at least a portion of the length of the frying chamber;
an inlet airlock at the first end, the inlet airlock configured to receive the food product carrier and translate the food product carrier into the frying chamber; and
an outlet airlock at the second end, the outlet airlock configured to receive the food product carrier from the internal conveyor and translate the food product carrier out of the frying chamber.

2. The frying system of claim 1, wherein the inlet airlock comprises:
a first door configured to transition between an open state exposing the inlet airlock to an external environment and a closed state sealing the inlet airlock from the external environment; and
a second door configured to transition between an open state exposing the inlet airlock to the frying chamber and a closed state sealing the inlet airlock from the frying chamber.

3. The frying system of claim 2, wherein:
a bottom surface of the inlet airlock comprises the second door of the inlet airlock; and
the second door of the inlet airlock is configured to rotate between the open state and the closed state.

4. The frying system of claim 3, wherein:
in the open state, the second door of the inlet airlock defines a slope extending toward the internal conveyor.

5. The frying system of claim 1, wherein the outlet airlock comprises:
a first door configured to transition between an open state exposing the outlet airlock to the frying chamber and a closed state sealing the outlet airlock from the frying chamber; and
a second door configured to transition between an open state exposing the outlet airlock to an external environment and a closed state sealing the outlet airlock from the external environment.

6. The frying system of claim 5, wherein:
a bottom surface of the outlet airlock comprises the second door of the outlet airlock; and
the second door of the outlet airlock is configured to rotate between the open state and the closed state.

7. The frying system of claim 6, wherein:
in the open state, the second door of the outlet airlock defines a slope extending into the external environment.

8. The frying system of claim 1, further comprising a mechanism configured to translate the food product carrier from the internal conveyor into the outlet airlock.

9. The frying system of claim 1, further comprising:
a filtration system configured to:
receive cooking oil from the frying chamber;
filter the cooking oil; and
recirculate the filtered cooking oil into the frying chamber.

10. The frying system of claim 9, further comprising:
a heating system configured to heat the filtered cooking oil before recirculation into the frying chamber.

11. The frying system of claim 9, wherein:
the frying chamber comprises a sloped bottom surface configured to direct particulates and residues toward an inlet to the filtration system.

12. The frying system of claim 1, wherein:
the frying chamber is configured to maintain a pressurized cooking environment.

13. The frying system of claim 1, wherein:
the food product carrier is configured to receive a food product and comprises a porous structure allowing heated cooking oil to flow into the food product carrier.

14. A frying system comprising:
a frying chamber configured to hold a volume of heated cooking oil, the frying chamber comprising:
a first end and second end defining a length of the frying chamber; and
an internal conveyor; and
an inlet at the first end, the inlet configured to introduce a food product carrier into the frying chamber, wherein:
the internal conveyor is configured to receive and horizontally translate the food product carrier through the volume of heated cooking oil along at least a subset of the length toward the second end.

15. The frying system of claim 14, wherein:
the food product carrier comprises:
a bottom surface;
a plurality of sidewalls arranged orthogonally to the bottom surface; and
a plurality of voids in at least one of the bottom surface or the sidewalls.

16. The frying system of claim 15, wherein:
the food product carrier comprises a top surface; and
at least one of the bottom surface or the top surface is hingedly connected to one of the sidewalls to allow opening and closing of the carrier.

17. The frying system of claim 14, further comprising:
an external conveyor configured to advance the food product carrier toward the inlet.

18. The frying system of claim 17, further comprising:
a stage platform positioned between the external conveyor and the inlet and configured to receive the food product carrier from the conveyor; and
an actuator positioned adjacent to the stage platform and configured to advance food product carriers from the stage platform into the inlet.

19. The frying system of claim 18, further comprising:
a hopper configured to store a plurality of food product carriers and sequentially introduce the food product carriers onto the external conveyor.

20. A method of frying food products, the method comprising:
directing a food product carrier containing a food product into a frying chamber via an inlet airlock, wherein:
the frying chamber contains a volume of heated cooking oil; and
the food product carrier comprises a food product;
horizontally translating the food product carrier through the frying chamber via an internal conveyor to direct the food product through the volume of heated cooking oil; and
directing the food product carrier out of the frying chamber via an outlet airlock.
